(19) United States
(12) Patent Application Publication
(10) Pub. No.: US 2008/0150359 A1
(43) Pub. Date: Jun. 26, 2008

(54) Semiconductor device and power supply for the same

(75) Inventor: Junji Yamada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY, INC., Tokyo (JP)

(21) Appl. No.: 12/000,884

(22) Filed: Dec. 18, 2007

(30) Foreign Application Priority Data
Dec. 22, 2006 (JP) 2006-345439

(51) Int. Cl. H02J 1/00; H02J 3/00

(52) U.S. Cl. 307/28; 307/18

(57) ABSTRACT

Low-potential side power supply lines and high-potential side power supply lines of n internal components making up a semiconductor device are sequentially connected in series between a ground voltage GND and a power supply VD. Voltage of a value obtained by adding values of predetermined operating voltage of the components is supplied as power supply for the entire device such that a differential voltage between the low-potential side and high-potential side wiring lines of each component is the predetermined operating voltage. Electric current flowing through the semiconductor device is reduced to 1/n, enabling reduction of voltage drop in the wiring lines.

This application is based upon and claims the benefits of priority from Japanese patent application No. 2006-345439 filed on Dec. 22, 2006, the disclosure of which is incorporated herein in its entirety by reference.

### BACKGROUND OF THE INVENTION

1. Field of the Invention

The present invention relates to semiconductor devices and, in particular, to power supply for semiconductor devices.

2. Description of the Related Art

Conventionally, power supply to a semiconductor device is performed by connecting the power supply in parallel to a plurality of internal circuits making up the semiconductor device.

Referring to FIG. 1, a semiconductor device 1 for example is formed by a single semiconductor chip, whose internal circuit region is composed of four internal circuit regions 1-A, 1-B, 1-C, 1-D. These four internal circuit regions are connected in parallel, while the low-potential side of the internal circuit regions is connected to a ground potential line GND and the high-potential side is connected to a power supply voltage VDD. It is assumed for example that the semiconductor device 1 is a semiconductor device operating at a power supply voltage of 1.8 V and a power consumption of 3.6 W, and the power consumption of each of the four internal circuit regions is 0.9 W. In this case, an electric current of 0.5 A flows through the internal circuit regions, and an electric current 2 A is supplied from the power supply VDD. Therefore, large voltage drop occurs in the power supply line.

In the case of a multi-chip package (MCP) semiconductor device composed of a plurality of semiconductor chips, power supply voltage is supplied in parallel to the individual semiconductor chips. As shown in FIG. 2, for example, a stacked semiconductor device 20 is formed by stacking four semiconductor chips (20-A, 20-B, 20-C, 20-D) having through electrodes. The corresponding through electrodes between the semiconductor chips are connected in series to each other and connected to a power supply voltage VDD or ground potential. When it is assumed for example that an internal circuit 21 of each of the four semiconductor chips operates at a power supply voltage of 1.8 V and power consumption of 0.9 W, the semiconductor device 20 will operate at a power supply voltage of 1.8 V, while the power consumption of the semiconductor device 20 will be a total of the four semiconductor chips, namely 3.6 W. In this case, an electric current of 0.5 A flows through the semiconductor chips and an electric current of 2 A is supplied from the power supply VDD. Therefore, a current of 2 A is supplied to the through electrode in the lowermost semiconductor chip, while a current of 0.5 A or higher is supplied to the through electrodes in the semiconductor chips other the uppermost one. Therefore, large voltage drop occurs in the through electrodes.

In order to reduce the voltage drop in a power supply path, there are known techniques for reducing the resistance of the power supply path itself. For example, Japanese Laid-Open Patent Publication 2004-260059 (Patent Reference 1) discloses a technique in which voltage drop is controlled by connecting between a power supply pad for internal circuit of a flip-chip type semiconductor device and a power supply pad for input/output buffer by means of aluminum wiring in the uppermost layer.

### SUMMARY OF THE INVENTION

The problem of voltage drop occurring in power current paths during power supply has become more notable as a result of refinement of circuit configuration, reduction of power supply voltage, and increase of power consumption.

Patent Reference 1 mentioned in the above tries to solve this problem by reducing the resistance of a power supply path itself.

The present invention seeks to solve the problem mentioned above by improving the connection of the power supply voltage supply path.

The present invention provides a semiconductor device composed of a plurality of components, wherein low-potential side power supply lines and high-potential side power supply lines of the plurality of components are connected such that the components are sequentially connected in series with respect to power supply voltage, so that the semiconductor device is supplied with power supply voltage of a value obtained by adding values of predetermined operating voltage of the respective components.

Desirably, a capacitor is arranged between the low-potential side power supply line and the high-potential side power supply line of each of the plurality of components.

According to one aspect of the present invention, the semiconductor device is composed of a single semiconductor chip, and the plurality of components are n (n is a natural number of two or more) internal circuit regions obtained by dividing the internal circuit of the semiconductor chip into n regions such that they consume substantially equivalent power. Connection is made such that the low-potential side power supply lines of the n internal circuit regions are respectively supplied with ground voltage and voltage of values obtained by multiplying the predetermined operating voltage value by one, two, . . . , and (n−1) while the high-potential side power supply lines are respectively supplied with voltage of values obtained by multiplying the predetermined operating voltage value by one, two, . . . , (n−1), and n, and the respective internal circuit regions are supplied with the predetermined operating voltage.

According to another aspect of the present invention, the semiconductor device is a multi-chip package semiconductor device having a plurality of semiconductor chips as the plurality of components. Low-potential side power supply lines and high-potential side power supply lines of the plurality of semiconductor chips are connected such that the semiconductor chips are sequentially connected in series with respect to power supply voltage, so that the semiconductor device is supplied with power supply voltage of a value obtained by adding values of the predetermined operating voltage of the respective components.

According to still another aspect of the invention, the semiconductor device is a multi-chip package semiconductor device having n (n is a natural number of two or more) semiconductor chips with identical configuration as the plurality of components. Connection is made such that the low-potential side power supply lines of the n internal circuit regions are respectively supplied with ground voltage and voltage of values obtained by multiplying the predetermined operating voltage value by one, two . . . , and (n−1) while the high-potential side power supply lines are respectively supplied with voltage of values obtained by multiplying the predetermined operating voltage value by one, two, . . . , (n−1), and n, and the respective internal circuit regions are supplied with the predetermined operating voltage.

According to still another aspect of the invention, the semiconductor device is a stacked semiconductor device formed by stacking a plurality of semiconductor chips as the plurality of components. Low-potential side power supply lines and high-potential side power supply lines of the plurality of semiconductor chips are connected such that the semiconductor chips are sequentially connected in series with respect to power supply voltage, and the semiconductor device is supplied with power supply voltage of a value obtained by adding values of the predetermined operating voltage of the respective semiconductor chips.

According to still another aspect of the invention, the semiconductor device is a stacked semiconductor device formed by stacking n (n is a natural number of two or more) semiconductor chips having identical configuration as said plurality of components. Connection is made such that the low-potential side power supply lines of the n semiconductor chips are respectively supplied with ground voltage and voltage of values obtained by multiplying the predetermined operating voltage value by one, two . . . , and (n−1) while the high-potential side power supply lines are respectively supplied with voltage of values obtained by multiplying the predetermined operating voltage value by one, two, . . . , (n−1), and n, and the respective semiconductor chips are supplied with the predetermined operating voltage.

Further, the present invention provides a power supply method for a semiconductor device composed of a plurality of components, wherein low-potential side power supply lines and high-potential side power supply lines of the plurality of components are connected such that the components are sequentially connected in series with respect to power supply voltage, and the semiconductor device is supplied with power supply voltage of a value obtained by adding values of predetermined operating voltage of the respective components.

According to the present invention, the semiconductor device has an internal circuit divided into n regions consuming equivalent power or is composed of n semiconductor chips also consuming equivalent power. These internal circuit regions or semiconductor chips are connected in series in terms of the supply of power supply voltage. The semiconductor device is supplied with the power supply voltage of a value obtained by adding values of predetermined operating voltage of the internal circuit regions or the semiconductor chips. In this manner, the plurality of the internal circuit regions or semiconductor chips can be operated while controlling the increase of electric current to be supplied. As a result, the voltage drop in the wiring lines can be reduced.

### BRIEF DESCRIPTION OF THE DRAWINGS

FIG. 1 is a schematic diagram showing power supply to internal circuit regions of a semiconductor device according to a related art;

FIG. 2 is a schematic diagram showing power supply to semiconductor chips of a stacked semiconductor device using through electrodes according to a related art;

FIG. 3 is a schematic diagram of a first exemplary embodiment of the present invention showing power supply to internal circuit regions of a semiconductor device;

FIG. 4 is a schematic diagram of a second exemplary embodiment of the present invention showing power supply to semiconductor chips of a multi-chip package semiconductor device; and

FIG. 5 is a cross-sectional view showing power supply to semiconductor chips of a stacked semiconductor device using through electrodes according to the second exemplary embodiment of the present invention.

### DESCRIPTION OF THE EXEMPLARY EMBODIMENTS

A semiconductor device according to preferred embodiments of the present invention will be described with reference to the accompanying drawings.

### First Exemplary Embodiment

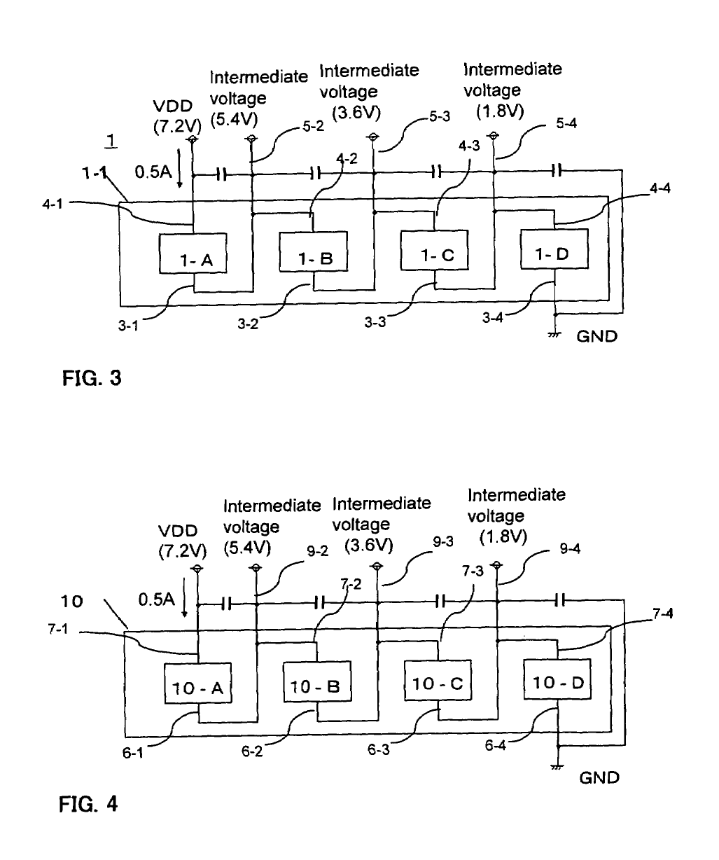

A first exemplary embodiment of the present invention will be described with reference to FIG. 3. FIG. 3 is a schematic diagram showing power supply to internal circuit regions of a semiconductor device.

As shown in FIG. 3, the semiconductor device 1 has a chip, which includes an internal circuit 1-1. The internal circuit 1-1 is divided into four regions (1-A, 1-B, 1-C, 1-D) consuming substantially same power. It is assumed here, for example, that the power consumption of the entire semiconductor device is 3.6 W, the power consumption of each internal circuit region being 0.9 W, and the operating voltage is 1.8 V. The internal circuit 1-1 includes low-potential side internal wiring lines and high-potential side internal wiring lines for the four regions (1-A, 1-B, 1-C, 1-D). The low-potential side internal wiring line (3-1) of the internal circuit region (1-A) is connected to the high-potential side internal wiring line (4-2) of the internal circuit region (1-B). Likewise, the low-potential side internal wiring line (3-2) of the internal circuit region (1-B) is connected to the high-potential side internal wiring line (4-3) of the internal circuit region (1-C). Further, the low-potential side internal wiring line (3-3) of the internal circuit region (1-C) is connected to the high-potential side internal wiring line (4-4) of the internal circuit region (1-D). Finally, the high-potential side wiring line (4-1) of the internal circuit region (1-A) is connected to a power supply terminal via a lead line. The power supply terminal is supplied with a power supply voltage VDD of 7.2 V by a power supply. On the other hand, the low-potential side wiring line (3-4) of the internal circuit region (1-D) is connected to a ground terminal via a lead line to receive ground potential of the power supply.

Accordingly, the internal circuit regions are connected in series with respect to the power supply, while each of the low-potential side internal wiring lines and each of the high-potential side internal wiring lines are connected in series, forming a current supply path for supplying current to the semiconductor device 1.

An inter-connecting wiring line is led out from each connection between the low-potential side wiring lines and the high-potential side wiring lines. The inter-connecting wiring line is supplied with an intermediate voltage between the ground and the power supply voltage VDD. The intermediate voltage is set such that the difference between voltages applied to the high-potential side wiring line and the low-potential side wiring line in each of the internal circuit regions (1-A, 1-B, 1-C, 1-D) is a predetermined operating voltage (1.8 V) for the internal circuit regions. Specifically, the inter-connecting wiring lines (5-4, 5-3, 5-2) are supplied with a voltage of 1.8V, 3.6V, and 5.4V, respectively, via connection terminals.

Further, a capacitor is connected to form capacitance between the ground and the inter-connecting wiring line (5-4), between the inter-connecting wiring lines, and between the inter-connecting wiring line (5-3) and the power supply line.

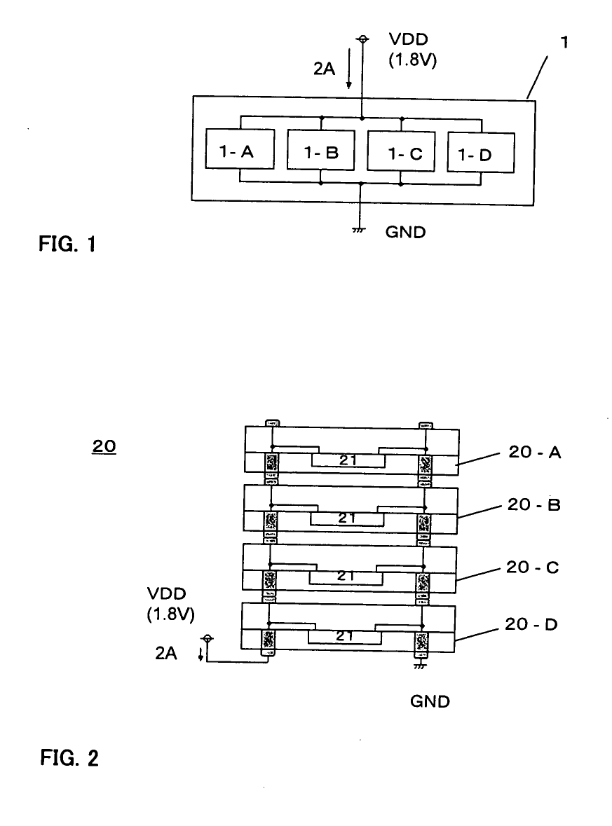

When the semiconductor device is operated with the internal circuit regions connected as described above and with the power supply VDD of 7.2V, electric current of 0.5 A will flow through the internal circuit regions and the power supply lines including the low-potential side wiring lines and high-potential side wiring lines.

Whereas an electric current of 2 A flows through power supply lines according to the related art shown in FIG. 1, the present embodiment of the invention reduces the electric current to 0.5 A, a quarter in comparison with that of the related art. The reduction of the electric current enables reduction of voltage drop caused by the power supply wiring. When the power supply wiring has a resistance value R, for example, the power supply voltage will drop by 2 R down to a voltage of (1.8 V-2 R) according to the related art. According to the present invention, in contrast, the power supply voltage drops only by 0.5 R, and the power supply voltage to the actual internal circuit regions will be (1.8 V-0.5 R) even after the drop.

As described above, when the power supply lines are connected in series, any variation in power consumption among the internal circuit regions will lead to variation in voltage supplied to the internal circuit regions. According to the present invention, the power supply lines mutually connecting the internal circuit regions in series are led out as intermediate power supply lines and intermediate voltages are supplied thereto, whereby variation in voltage caused by variation in power can be absorbed. These intermediate power supply lines only have to be supplied with electric current corresponding to the variation in power between the internal circuit regions, and hence very low resistance may not be required of the power supply lines. Further, as for the variation in power occurring in a short period of time, the variation in voltage associated thereto can be absorbed by connecting a capacitance.

The semiconductor device according to the first exemplary embodiment of the invention has an internal circuit divided into n (n is a natural number of two or more) regions, and the low-potential side and high-potential side power supply lines of the internal circuit regions are connected in series. A voltage that is n times higher than a predetermined operating voltage is supplied as power supply, while the predetermined operating voltage is supplied to each of the internal circuit region via the corresponding intermediate power supply line.

Electric current flowing through the semiconductor device is reduced to 1/n, whereby the drop in the power supply voltage can be reduced to 1/n. Further, the variation in voltage can be absorbed by providing a capacitance between the power supply lines between the internal circuit regions.

### Second Exemplary Embodiment

A second exemplary embodiment of the present invention will be described with reference to the drawings.

Referring to FIG. 4, a semiconductor device 10 is a multi-chip package semiconductor device having a plurality of semiconductor chips, and its power supply is illustrated.

The semiconductor device 10 has four semiconductor chips (10-A, 10-B, 10-C, 10-D) mounted thereon. It is assumed here that these semiconductor chips operate with an operating voltage of 1.8 V and a power consumption of 0.9 W (electric current of 0.5 A).

The semiconductor chips (10-A, 10-B, 10-C, 10-D) each include a low-potential side wiring line and a high-potential side wiring line. The low-potential side wiring line (6-1) of the semiconductor chip (10-A) is connected to the high-potential side wiring line (7-2) of the semiconductor chip (10-B). An inter-connecting wiring line (9-2) is led out from the connecting point between these lines. Likewise, the low-potential side wiring line (6-2) of the semiconductor chip (10-B) is connected to the high-potential side wiring line (7-3) of the semiconductor chip (10-C), and an inter-connecting wiring line (9-3) is led out from the connecting point between these lines. The low-potential side wiring line (6-3) of the semiconductor chip (10-C) is connected to the high-potential side wiring line (7-4) of the semiconductor chip (10-D), and an inter-connecting wiring line (9-4) is led out from the connecting point between these lines. Further, the high-potential side wiring line (7-1) of the semiconductor chip (10-A) is connected to a power supply terminal via a lead line. A power supply voltage VDD of 7.2 V is supplied to the power supply terminal from a power supply. On the other hand, the low-potential side wiring line (6-4) of the semiconductor chip (10-D) is connected to a ground terminal, via a lead line, to be supplied with ground potential from the power supply.

Accordingly, the semiconductor chips are connected in series with respect to the power supply, and the low-potential side and high-potential side wiring lines are connected in series to the electric current supply paths connected in series to the power supply of the semiconductor device 1.

The inter-connecting wiring lines are each supplied with an intermediate voltage between the ground and the power supply voltage VDD. The intermediate voltage is set such that the differential voltage between the high-potential side wiring line and the low-potential side wiring line of each of the semiconductor chips (10-A, 10-B, 10-C, 10-D) becomes a predetermined operating voltage (for example, 1.8 V) for the chip. Specifically, the inter-connecting wiring lines (9-4, 9-3, 9-2) are supplied with a voltage of 1.8 V, 3.6 V, and 5.4V, respectively.

Further, a capacitor is connected to form capacitance between the ground and the inter-connecting wiring line (9-4), between the inter-connecting wiring lines, and between the inter-connecting wiring line (9-2) and the power supply line.

Each of the semiconductor chips (10-A, 10-B, 10-C, 10-D) is activated by being supplied with a voltage such that the differential voltage between the high-potential side and low-potential side wiring lines thereof becomes a predetermined operating voltage (1.8 V). In this case, an electric current of 0.5 A flows through the semiconductor chips. The electric current flowing through the semiconductor chips is reduced to a quarter, namely 0.5 A according to present invention, whereas electric current flowing through semiconductor chips is 2 A when the power supply is connected in parallel as shown in FIG. 2. The reduction of the electric current enables reduction of voltage drop caused by the power supply lines.

As described above, when the power supply line is connected in series, any variation in power consumption among the internal circuit regions will lead to variation in voltage supplied to the internal circuit regions. According to the second exemplary embodiment of present invention, the power supply lines mutually connecting the internal circuit regions in series are led out as intermediate power supply lines and an intermediate voltage is supplied to each of them, whereby variation in voltage caused by variation in power can be absorbed. These intermediate power supply lines only have to be supplied with electric current corresponding to the variation in power between the internal circuit regions, and hence very low resistance may not always be required of the power supply lines. Further, as for the variation in power occurring in a short period of time, the variation in voltage associated thereto can be absorbed by connecting a capacitor.

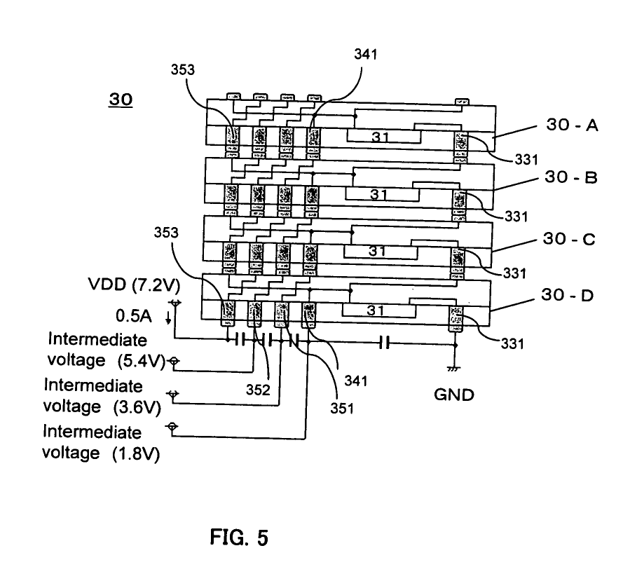

FIG. 5 shows an example in which the semiconductor device shown in FIG. 4 is applied to a multi-chip semiconductor device having a plurality of semiconductor chips stacked.

As shown in FIG. 5, elements each including a semiconductor chip (30-A, 30-B, 30-C, 30-D) are stacked and connected to each other via through electrodes in the chips. Each of the semiconductor chips has an internal integrated circuit 31 and three through electrodes in addition to a low-potential side through electrode and a high-potential side through electrode. Each of the elements includes an insulating layer formed on the surface of the semiconductor chip, and wiring lines formed within the insulating layer. The through electrodes are connected to the respective wiring lines and connected to terminals formed on the surface of the insulating layer. Further, there are also formed terminals connected to the through electrodes on the face of the semiconductor chip opposite from the insulating layer. An internal circuit 31 of each of the element chips except for the uppermost chip has its low-potential side wiring line connected to its through electrode 331. The high-potential side wiring line is connected to a through electrode 341 and also connected to a low-potential side wiring line of the semiconductor chip stacked thereon via the through electrode 331 of this stacked chip. Through electrodes 351, 352, 353 of each chip are electrically connected to through electrodes of the chip stacked thereon, such that they are each connected to the through electrode of the upper-layer element that is offset from the corresponding through electrode of the lower-layer element by a distance corresponding to a pitch between the through electrodes. The high-potential side through electrode 341 is connected to the terminal at a position corresponding to the position of the through electrode 353 of the upper-layer element. The chips are stacked such that the respective through electrodes are aligned with the corresponding through electrodes of the upper-layer element. The through electrodes 341, 351, 352 of the lowermost element are each supplied with an intermediate voltage. The low-potential side through electrode 331 is supplied with a ground potential GND via a ground wiring line. On the other hand, the through electrode 353 is supplied with a power supply potential VDD.

A capacitance element is formed each between the low-potential side through electrode 331 and the high-potential side through electrode 341, between the high-potential side through electrode 341 and the through electrode 351, between the through electrodes 351 and 352, and between the through electrode 352 and the through electrode 353. Accordingly, in this semiconductor device, including from the lowermost semiconductor chip to the uppermost semiconductor chip, a serial connection is established between the ground and the power supply voltage VDD in terms of the supply of power supply voltage. The low-potential side wiring lines and high-potential side wiring line in the chips are also connected in series as a power supply path. The high-potential side through electrodes of the chips except for the uppermost chip, specifically those of the lowermost chip, the second from the lowermost chip, and the third from the lowermost chip are supplied with an intermediate voltage of 1.8 V, 3.6 V, and 5.4 V, respectively.

The through electrodes to be used in the semiconductor chip according to the present invention may be, for example, those disclosed in Japanese Laid-Open Patent Publication No. 2002-305283.

Each of the semiconductor chips (30-A, 30-B, 30-C, 30-D) is activated by being supplied with a predetermined operating voltage (1.8 V) between the high-potential side wiring line and the low-potential side wiring line thereof. In this case, electric current of 0.5 A flows through the semiconductor chips. When the power supply is connected in parallel as shown in FIG. 2, electric current flowing through semiconductor chips will be a total of four chips, namely 2 A, whereas according to this second exemplary embodiment of the invention, the electric current is reduced to 0.5 A that is equivalent to the electric current of only one chip.

In the exemplary embodiments described above, the internal circuit regions or the semiconductor chips operate with a same operating voltage and power. However, the present invention is not limited to this and is also applicable to a case in which the internal circuit regions or the semiconductor chips operate with different operating voltages but with a substantially same operating current. In the exemplary embodiment shown in FIG. 5, for example, the semiconductor chip 30-A, 30-B, 30-C may be operated with an operating voltage of 1.8 V and an operating current of 0.5 A while the semiconductor chip 30-D may be operated with an operating voltage of 1.5V and an operating current of 0.5 A.

In this case, it will suffice to supply a voltage, as an intermediate voltage to the respective semiconductor chips, obtained by sequentially adding the respective operating voltages in the power supply direction from the ground GND. Specifically, intermediate voltages of 1.5 V, 3.3 V and 5.1 V, and a power supply voltage VDD of 6.9 V are supplied to the semiconductor chips, respectively. The supply of the voltage obtained by adding respective operating voltages enables each of the semiconductor chips to be supplied with the predetermined operating voltage of 1.5V or 1.8V through the low-potential side and high-potential side wiring lines.

According to the present invention, the low-potential side and high-potential side wiring lines of the n components forming the semiconductor device are connected in series between the ground voltage GND and power supply VDD, so that a predetermined operating voltage is supplied to each of the components. If the semiconductor device is composed of a single chip, the internal circuit is divided into a plurality of regions as the components such that the current consumption is the same among the components. If the semiconductor device is composed of a plurality of semiconductor chips, these semiconductor chips are the components, each of which is supplied with a voltage obtained by adding the predetermined operating voltages as the intermediate power supply or the power supply VDD. The voltage is supplied such that the differential voltage between the low-potential side and high-potential side wiring lines of each internal component is equal to the predetermined operating voltage. This configuration reduces the electric current flowing through the semiconductor device to 1/n, which enables the reduction of the drop of the power supply voltage to 1/n. Further, the provision of a capacitance between the power supply lines of the respective internal components makes it possible to absorb variation in voltage.

Having described exemplary embodiments of the present invention in a rather specific manner, the present invention is not limited to these exemplary embodiments. It should be understood that various modifications can be made without departing from the spirit and scope of the invention, and all such modifications are also covered by the appended claims.

What is claimed is:

1. A semiconductor device comprising a plurality of components, wherein low-potential side power supply lines and high-potential side power supply lines of the plurality of components are connected such that the components are sequentially connected in series with respect to power supply voltage, and the semiconductor device is supplied with a power supply voltage of a value obtained by adding values of predetermined operating voltage of the respective components.

2. The semiconductor device according to claim 1, wherein a capacitor is arranged between the low-potential side power supply line and the high-potential side power supply line of each of the plurality of components.

3. The semiconductor device according to claim 1, wherein;
the semiconductor device is composed of a single semiconductor chip, said plurality of components being n (n is a natural number of two or more) internal circuit regions obtained by dividing the internal circuit of the semiconductor chip into n regions; and
connection is made such that the low-potential side power supply lines of the n internal circuit regions are respectively supplied with a ground voltage and voltages of values obtained by multiplying the predetermined operating voltage value by one, two, . . . , and (n−1) while the high-potential side power supply lines are respectively supplied with voltages of values obtained by multiplying the predetermined operating voltage value by one, two, . . . , (n−1), and n, and the respective internal circuit regions are supplied with the predetermined operating voltage.

4. The semiconductor device according to claim 1, wherein:
the semiconductor device is a multi-chip package semiconductor device having a plurality of semiconductor chips as the plurality of components; and
low-potential side power supply lines and high-potential side power supply lines of the plurality of semiconductor chips are connected such that the semiconductor chips are sequentially connected in series with respect to a power supply voltage, and the semiconductor device is supplied with power supply voltage of a value obtained by adding values of the predetermine operating voltage of the respective semiconductor chips.

5. The semiconductor device according to claim 1, wherein;
the semiconductor device is a multi-chip package semiconductor device having n (n is a natural number of two or more) semiconductor chips with same configuration as the plurality of components; and
connection is made such that the low-potential side power supply lines of the n semiconductor chips are respectively supplied with a ground voltage and voltages of values obtained by multiplying the predetermined operating voltage value by one, two, . . . , and (n−1) while the high-potential side power supply lines are respectively supplied with voltages of values obtained by multiplying the predetermined operating voltage value by one, two, . . . , (n−1), and n, and the respective semiconductor chips are supplied with the predetermined operating voltage.

6. The semiconductor device according to claim 1, wherein:
the semiconductor device is a stacked semiconductor device formed by stacking a plurality of semiconductor chips as the plurality of components; and
low-potential side power supply lines and high-potential side power supply lines of the plurality of semiconductor chips are connected such that the semiconductor chips are sequentially connected in series with respect to power supply voltage, and the semiconductor device is supplied with a power supply voltage of a value obtained by adding values of the predetermined operating voltage of the respective semiconductor chips.

7. The semiconductor device according to claim 1, wherein;
the semiconductor device is a stacked semiconductor device formed by stacking n (n is a natural number of two or more) semiconductor chips having same configuration as the plurality of components; and
connection is made such that the low-potential side power supply lines of the n semiconductor chips are respectively supplied with a ground voltage and voltages of values obtained by multiplying the predetermined operating voltage value by one, two, . . . , and (n−1) while the high-potential side power supply lines are respectively supplied with voltage of values obtained by multiplying the predetermined operating voltage value by one, two, . . . , (n−1), and n, and the respective semiconductor chips are supplied with the predetermined operating voltage.

8. The semiconductor device according to claim 7, wherein connection is made such that the high-potential side power supply line of each of the stacked semiconductor chips is connected to the low-potential side power supply line of the semiconductor chip located thereon, while a predetermined power supply potential is supplied to the high-potential side power supply line of said lower semiconductor chip via a through electrode, and a potential lower than said predetermined power supply potential is supplied to the low-potential side power supply line of the lower semiconductor chip via another through electrode.

9. A power supply method for a semiconductor device comprising a plurality of components, wherein low-potential side power supply lines and high-potential side power supply lines of the plurality of components are connected such that the components are sequentially connected in series with respect to power supply voltage, and the semiconductor device is supplied with power supply voltage of a value obtained by adding values of predetermined operating voltage of the respective components.
